(19) United States
(12) Patent Application Publication
(10) Pub. No.: US 2003/0103714 A1
(43) Pub. Date: Jun. 5, 2003

(54) Wavelength -selective module

(76) Inventor: Joseph H Abeles, Highland Park, NJ (US)

Correspondence Address: DUANE MORRIS LLP, 100 COLLEGE ROAD WEST, SUITE 100, PRINCETON, NJ, 08540-6604, US

(21) Appl. No.: 10/181,468

(22) PCT Filed: Jan. 22, 2001
(86) PCT No.: PCT/US01/02072

(51) Int. Cl. G02B 6/35; G02B 6/26; G02B 6/12

(52) U.S. Cl. 385/16; 385/15; 385/14

(57) ABSTRACT

A wavelength-selective module for use in a telecommunications network, having an enclosure and a wavelength tunable optical switch disposed in the enclosure. The switch includes an array of wavelength-selective optical switch elements defining a plurality of switch cross-point junctions. A fiber optic input connection of the module receives multiple optical carriers which are separated at the switch cross-point junctions for transmission at the fiber optic output.

### PROVISIONAL APPLICATION

This application claims the benefit of Provisional application 60/176,916 filed Jan. 20, 2000.

### FIELD OF THE INVENTION

The present invention relates to modules containing multiple wavelength-selective photonic devices, including the capability of wavelength-tuning, which perform on wavelength-division-multiplexed optical carriers functions useful in telecommunications networks and other applications, such as switching, combining, adding, dropping, or equalization, either alone or in combination with other components.

### BACKGROUND OF THE INVENTION

There is a need for compact, inexpensive modules capable of performing signal processing, switching, and other functions for the optical layer. The presently deployed optical layer consists primarily of point-to-point optically carried links, an increasing proportion of which are wavelength-division-multiplexed. Such modules are needed where processing or switching needs to be performed on a wavelength-by-wavelength basis. An example would be gain equalization where certain optical carriers need to be boosted in optical power relative to others before relaying while avoiding a costly conversion to electronic signal form. In future wavelength-switched telecommunications network applications the need for modules of the kind discussed here can be anticipated to proliferate due to the need to switch optical carriers on a wavelength-by-wavelength basis, to combine multiple modulated optical carriers of varying wavelengths in systems where the wavelength of the optical carrier incoming on a given port cannot be fixed in advance, and for a variety of other applications associated with optical level switching.

Currently, a significant variety of optical switch technologies is being considered for millisecond- or microsecond-scale switching of optical carriers. These include liquid crystal, microelectronic-mechanical, microfluidic, deformable mirror, and others. None of these can support optical level switching for a packet-switched optically transparent network. For the circuit-switched optically transparent network that these technologies can support, it is not expected to be possible to adequately provision low-latency high-bandwidth connectivity as would be-required, e.g., for full video interaction between users.

A limited number of other optical switching technologies are being considered which in principle can provide the high-speed switching, i.e., nanosecond-rate switching, required for packet-switched optically transparent networks. For example, lithium niobate modulator technology can switch at the requisite rates. A drawback of the lithium niobate technology is that it is not adequately scalable duo to significant losses and large sizes of its switches. Scalability to at least the level of 256 wavelengths is required to support a dramatically increasing demand for bandwidth. There is, moreover, a crosstalk issue associated with lithium niobate technology. A smaller size switch array could be constructed using semiconductor optical amplifiers, but this array suffers from nonlinearity and power dissipation limitations which also are a challenge to scaling.

In general, however, none of the above technologies provide wavelength selectivity. That is, it is necessary to separately combine the above wavelength-insensitive switch arrays with separate wavelength splitters or combiners in order to separately operate on each individual optical carrier. A very great disadvantage of such an approach is the proliferation of input/output connections required using optical fiber or other optical approaches when splitting the signals carried on a single fiber into e.g., 256 fibers as required for systems containing 256 separate wavelengths carrying 256 separate optical carriers. This drawback becomes far more serious when contemplating systems having such multiple wavelength-division-multiplexed optical fibers converging on a switch.

Accordingly, an optical device is needed which is capable of separately operating on each wavelength in switching, adding, dropping, wavelength combining, equalization, or other signal processing applications.

### SUMMARY OF THE INVENTION

A wavelength-selective module for use in a telecommunications network comprises monolithically or hybrid integrated wavelength-selective optical switch elements which separate individual optical carriers, of differing frequency or wavelength, with optical separation loss substantially less than corresponding optical splitting losses, for the purpose of carrying out operations which modify the optical carrier separately for each carrier or group of carriers. One embodiment of such a module performs operations carried out free of interaction between channels, as for dispersion compensation or gain equalization applications. Another embodiment of such a module performs operations carried out between channels, e.g., comprises a wavelength tunable optical switch including an array of wavelength-selective optical switch elements defining a plurality of switch cross-point junctions; and fiber optic input and output connections for connecting the module in the telecommunications network. The fiber optic input connection of the module receives multiple optical carriers which are separated at the switch cross-point junctions for transmission at the fiber optic output.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1A is a plan view of a hermetically packaged wavelength-selective module according to an exemplary embodiment of the present invention;

FIG. 1B is a plan view of the module of FIG. 1A with the lid of the module enclosure removed;

FIG. 2 is a plan view of an exemplary a 1 cm×1 cm chip that can be employed in the module of the present invention;

FIG. 3A is a schematic diagram of a prior art fixed-wavelength optical carrier combiner;

FIG. 3B is a schematic diagram of a prior art fixed-wavelength optical carrier splitter;

FIG. 4A is a schematic diagram of a wavelength-selectable optical carrier combiner module according to an embodiment of the present invention;

FIG. 4B is a detailed view of a portion of the combiner of FIG. 4A;

FIG. 5A is a graph depicting an exemplary optical spectrum of a plurality of optical carriers as transmitted and 5B is a graph depicting the optical spectrum of these optical carriers after transmission; and

FIG. 6 is an equalizer module made according to an embodiment of the present invention.

### DETAILED DESCRIPTION OF THE INVENTION

Referring collectively to FIGS. 1A and 1B, a hermetically packaged wavelength-selective module 10 according to an exemplary embodiment of the present invention is shown. The module 10 integrates on a chip 20 which may be a semiconductor chip composed of InGaAsP materials, other III-V semiconductor materials, or non-III-V semiconductor materials such as Si, combinations of any of the aforementioned materials, or combinations of such materials with non-semiconductor materials capable of supporting waveguiding layers, a plurality of optical elements 22, at least certain ones of which are wavelength-selective for operating in applications such as crossbar switching, selective adding and dropping, combining, frequency translation, and level equalization of multiple optical carriers or subcarriers in optical transmission, signal processing, and switching networks. More specifically, the principles of the present invention may be employed in repeater applications including level equalizers and DWDM dispersion compensators; and in network element applications including wavelength-selective combiners, spectrum-sliced multi-wavelength sources, frequency converters, tunable OADMs (“AOTF” capable), and OXCs.

The module 10 includes one or more single-mode fiber-optic input and output high speed connectors 16, 18 in a small-size receptacle 12 hermetically sealed by a lid 14 that forms a hermetically scaled package for mounting on a printed circuit card within a functional system. The size of such a receptacle is intended to be such that many optical fibers, up to, e.g., 1000, can be connected to the wavelength selective module. Integration of the optical elements within the module may be accomplished using discrete or monolithic techniques on a medium- to large-scale, including combinations of monolithic and non-monolithic optical elements. The scale of integration as taught here is intended to represent up to, e.g., 1,000,000 elements as needed to interconnect up to 1000 optical carriers on 1000 fibers.

Along with the optical elements 22, there may also be integrated in the module 10 one or more electronic circuits which enhance the utility of the module 10. Such circuits may include those supporting transimpedance amplification, drivers, regeneration, packet header decoders, address resolvers, packet header re-writers, and controllers including switch controllers.

The optical elements 22 may include one or more of filters, switches, attenuators, modulators, detectors, amplifiers, cw sources, pulsed sources, and isolators detecting, emitting, or operating upon optical carriers, where it is understood that such carriers are typically modulated with digital or analog data.

The wavelength-selective optical elements 22 within the module, i.e., the optical switch elements which possess wavelength-dependent characteristic properties, are adapted so that the wavelength or wavelengths of operation of these elements 22 are selectable via a tuning or other wavelength selection mechanism. Wavelength-selectivity advantageously permits low-loss combining of multiple modulated optical carriers onto a single optical mode, such as that transmitted within an optical fiber, and additionally, permits the selection of individual optical carriers for individual processing separate from those at all other wavelengths. The wavelength selection mechanism may be electro-optic, mechano-optic, thermo-optic, piezo-optic, magneto-optic, all-optical or any other mechanism or means capable of varying the wavelength response of the optical elements, which are to be wavelength selective.

Wavelength-selectivity may typically be derived from an optical resonance, such that optical energy is stored transiently within the optical switch element at a higher energy density than is transmitted into or out of the element for optical frequencies at or near one or more characteristic resonant frequencies. Typically, the physical size of such an optical switch element is restricted such that the photon lifetime within the element is small compared with the inverse frequency of data modulated on the optical carrier of interest, thus leading to optical element sizes of less than 50 μm×50 μm, for example. Accordingly, an embodiment of the invention employing a 1 mm×1 mm chip can accommodate an X-Y array of more than 400 of these wavelength-selective optical switch elements and up to 10,000 of the same.

In one embodiment of the invention, as shown in FIG. 2, a 1 cm×1 cm chip 200 is employed which can accommodate an X-Y array of up to 1,000,000 wavelength-selective optical switch elements 220, thereby forming optical switch 210. A chip of that size containing an X-Y array of 1,000,000 wavelength-selective optical switch elements can accept at its input up to 1000 incoming optical waveguides, each containing 1000 incoming wavelength division multiplexed optical carriers. The wavelength-selective optical switch elements 220 reroute the optical carriers to 1000 outgoing optical waveguides each containing the same number of optical carriers. Passive waveguide arrays can be provided to allow coupling of each of the 2000 ports to optical fibers. The total bandwidth being switched if each incoming fiber contained 10,000 gigabits per second of data on 1000 optical carriers would be 10,000,000 gigabits per second of data, i.e., 10 petabits per second of data.

Control circuitry can be provided at each one of the crosspoints 221 of the optical switch 210 by bonding, such as bump-bonding, to a suitable ULSI electronic circuit, or else by integration of the electronic function on the same chip as the wavelength-selective optical elements 220. The speed of rearranging the optical switch 210 is likely to be limited by the speed of the electronic controller.

While such a large, petabit-scale switch is possible using wavelength-selective elements as mentioned, it is possible to achieve very significant increases in functionality over the prior art by employing smaller scale-switches. In particular, high speed connections can readily be included in the switch. The wavelength-selectable module of the present invention can include one or more of the functions described elsewhere herein.

It is an essential feature of the present invention that a particular utility may be achieved from combining the arraying of many wavelength-selectable elements in a single module, with simultaneous input and output of multiple optical carriers over a minimum number of optical fibers achieved through the use of wavelength-division multiplexed optical carriers.

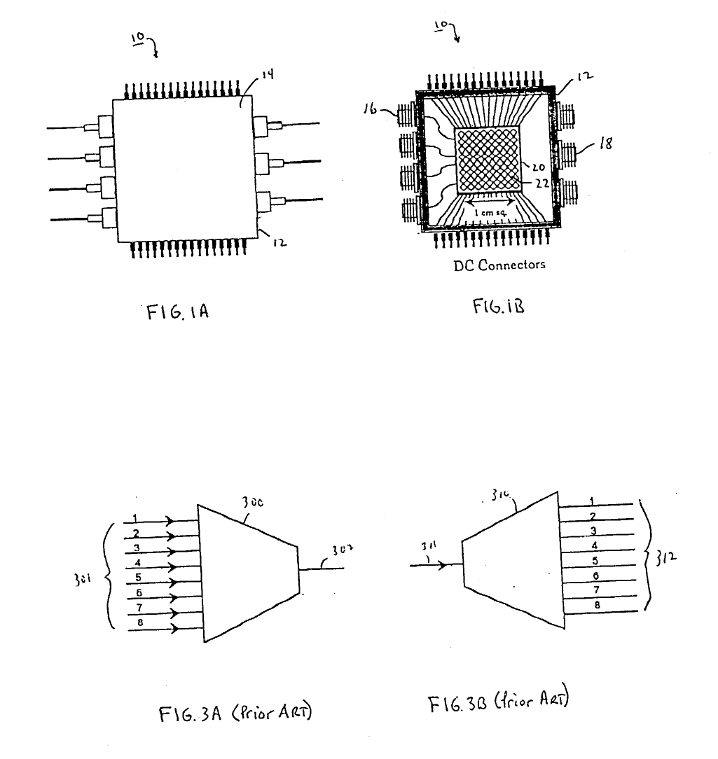

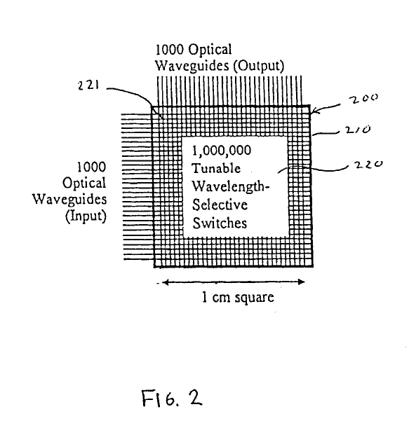

A particular application of wavelength-selectable module technology can be understood by reference to FIGS. 3A and 3B, which depict the operation of conventional wavelength division multiplexers/demultiplexers that are commercially available. FIG. 3A shows a fixed-wavelength optical carrier combiner 300 that combines multiple wavelengths without loss onto a single multiplexed output 302 with no excess loss only when the proper wavelengths are applied to the respective input ports 301 thereof (each input port 301 carries a single wavelength). FIG. 3B shows a fixed-wavelength optical carrier splitter 310 that splits multiple wavelengths apart from within a single fiber 311 via input port 311 with no excess loss, such that each output port 312 carries a single wavelength. A significant drawback for the use of such components in wavelength-switched networks is that the combiner 300 of FIG. 3A cannot operate properly due to the fact that the wavelength impinging on each input port cannot be known in advance in such a network configuration. This leads to the need for use of strictly passive combiners in place of wavelength division multiplexers for the combining function. Such passive combiners have a loss of 3 dB×log₂(N), where N is the number of ports as is widely known to those skilled in the art. For the example of N=256, the loss of such a combiner is 24 dB per wavelength. Compensation of this loss requires, at minimum, an amplifier to amplify all 256 carriers back up to approximately 10 dBm signal levels.

Furthermore, considering the non-excess loss associated with the passive combiner, it may be impossible to retrieve the signals which have dropped below the detectable limit, depending on bandwidth, following the total aggregate losses associated with the passive combiner, which may be 30 dB or more.

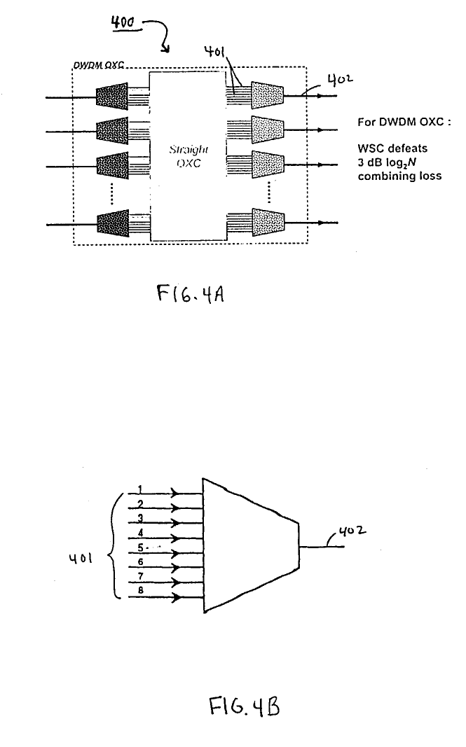

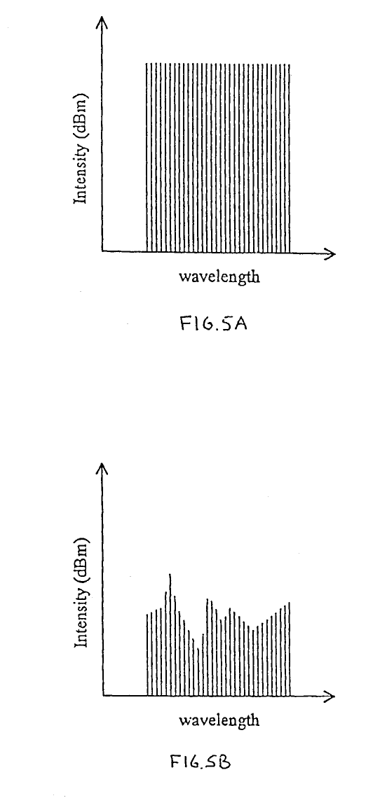

However, as shown in FIGS. 4A and 4B, the wavelength-selectable optical elements employed in the module of the present invention enable the module to be used as a wavelength-selectable optical carrier combiner 400 (FIG. 4A) with no passive loss. This is achieved, as shown in FIG. 4B, by tuning each input port 401 to one of the wavelengths entering therein from the network. All wavelengths are combined on a single output port 402. That wavelength is known by the system controller. Such a wavelength-selectable combiner module 400 may be used in combination with other non-wavelength-selectable crossbar switch technologies, regardless of speed or as part of a wavelength-selectable module as described herein.

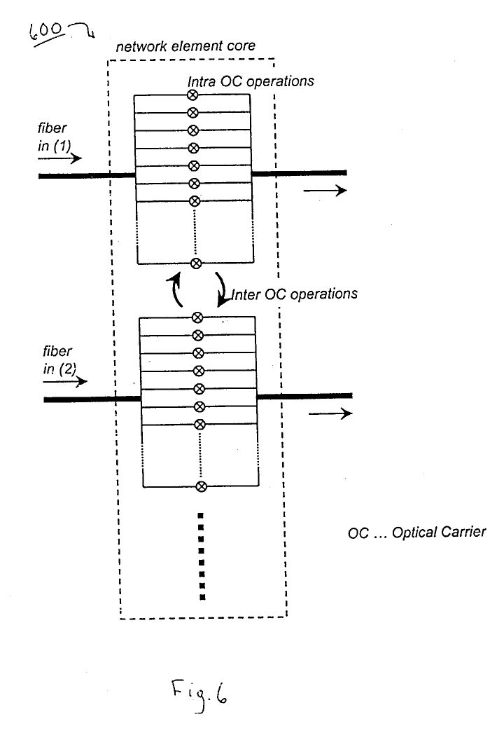

Another exemplary application for wavelength-selectable module of the present invention is level equalization. A difficulty encountered in transmission of multiple optical carriers is that various mechanisms, including lack of gain flatness of amplifiers, polarization mode dispersion, and other effects, cause the relative intensities of various optical carriers following transmission to become unequal as shown in FIGS. 5A and 5B. It is difficult to re-equalize the carriers with conventional technology because conventional approaches are cumbersome or do not operate individually on each optical carrier. However, the wavelength-selectable module of the present invention can be embodied as an equalizer module 600, as shown in FIG. 6, to permit each individual wavelength to be individually tested for amplitude, level-adjusted, and recombined with all other wavelengths to attain a balanced spectrum similar to the original equalized spectrum shown in FIG. 5A. The wavelength selective equalizer module 600 of FIG. 6 accomplishes equalization using operations which are carried out free of interaction between channels, i.e., intra optical carrier operations.

The wavelength-selectable module of the present invention can, following the above principles, be constructed to operate as add/drop demultiplexers, crossbar switchers, and can be configured to permit a variety of advanced functions useful for the wavelength switched network.

The wavelength-selectable optical elements contained within the wavelength-selectable module must be designed to accommodate the design criteria discussed above. In a preferred embodiment, the wavelength-selectable optical elements are implemented using four-port ring resonator wavelength-selective switches. Such switches are described in U.S. Ser. No. ______, entitled, “Channelizer Switch,” by Abeles, filed on ______, and incorporated herein by reference. The key feature of this switch is its wavelength-tunability, ability to isolate single optical carriers including modulation sidebands, and small size. At present, for operation in the 1550 nm wavelength band or 1310 wavelength band, each of which is standard for telecommunications, the underlying material from which such switches are constructed preferably from indium phosphide. That is because only indium-phosphide-based materials combine the requisite properties: high refractive index, ability to fabricate small single mode couplers, and ability to modulate refractive index or loss sufficiently to tune or switch the modulator. Among the architectures considered for these switches are laterally and vertically coupled architectures, where the orientation refers to the juxtaposition of the input and output waveguides with respect to the ring resonators. Additional candidates for resonant elements are those based on photonic bandgap materials.

While the foregoing invention has been described with reference to the above embodiments, various modifications and changes can be made without departing from the spirit of the invention. Accordingly, all such modifications and changes are considered to be within the scope of the appended claims.

What is claimed is:

1. A wavelength-selective module for use in a telecommunications network, the module comprising:
a wavelength tunable optical switch including an array of wavelength-selective optical switch elements defining a plurality of switch cross-point junctions; and
fiber optic input and output connections for connecting the module in the telecommunications network;
wherein the fiber optic input connection receives multiple optical carriers which are separated at the switch cross-point junctions for transmission at the fiber optic output.

2. The module according to claim 1, wherein the array of wavelength-selective optical switch elements are integrated on a chip.

3. The module according to claim 2, wherein the chip comprises a material capable of supporting waveguiding layers.

4. The module according to claim 3, wherein the material comprises a semiconductor material.

5. The module according to claim 3, wherein the material comprises III-V semiconductor material.

6. The module according to claim 5, wherein the III-V semiconductor material is indium phosphide based.

7. The module according to claim 6, wherein the III-V semiconductor material comprises InGaAsP.

8. The module according to claim 2, wherein the chip is about 1 cm by about 1 cm and includes up to about 1,000,000 of the wavelength-selective optical switch elements.

9. The module according to claim 2, wherein the chip is about 1 mm by about 1 mm and includes more than 400 of the wavelength-selective optical switch elements and up to about 10,000 of the wavelength-selective optical switch elements.

10. The module according to claim 1, wherein the wavelength-selective optical switch elements comprise resonator wavelength-selective switches.

11. The module according to claim 1, further comprising an enclosure, wherein the wavelength tunable optical switch is disposed in the enclosure.

12. The module according to claim 1, wherein the wavelength-selective optical switch elements comprise four port ring resonator wavelength-selective switches.

13. The module according to claim 1, wherein the wavelength tunable optical switch can interchange any two wavelengths along different paths.

14. The module according to claim 1, wherein the wavelength tunable optical switch can convert a wavelength from a first frequency to a second frequency.

15. The module according to claim 14, wherein the conversion from the first frequency to the second frequency is nonlinear.

16. A wavelength-selective module for dispersion compensation or gain equalization, the module comprising a wavelength tunable optical switch including an array of wavelength-selective optical switch elements for performing intra optical carrier operations that restore a spectrally unbalanced plurality of optical carriers to the carrier's original equalized spectrum.
